(19) United States
(12) Patent Application Publication
(10) Pub. No.: US 2004/0105662 A1
(43) Pub. Date: Jun. 3, 2004

(54) Method for recording a data stream having multiple reproduction paths and a recording medium having the data stream

(76) Inventors: Kang Soo Seo, Anyang (KR); Byung Jin Kim, Sungnam (KR); Soung Hyun Um, Anyang (KR)

Correspondence Address: HARNESS, DICKEY & PIERCE, P.L.C., P.O. BOX 8910, RESTON, VA, 20195, US

(21) Appl. No.: 10/720,121

(22) Filed: Nov. 25, 2003

(30) Foreign Application Priority Data
Nov. 27, 2002 (KR) 10-2002-0074240

(51) Int. Cl. H04N 5/781

(52) U.S. Cl. 386/95; 386/125

(57) ABSTRACT

The present invention relates to a method for recording a data stream having a multiple reproduction paths on a high-density optical disk. The present method ensures seamless presentation of video and audio data of a multi-path data stream by setting no-jumping sections to prohibit re-jump after jump. The no-jumping section whose total bit rate is not less than a minimum bit rate is able to remove possible buffer underrun even when the reproduction path is changed during reproduction.

### FOREIGN PRIORITY

The present invention claims priority under 35 U.S.C. 119 on Korean Application No. 10-2002-0074240 filed Nov. 27, 2002; the contents of which are incorporated by reference in their entirety.

### BACKGROUND OF THE INVENTION

1. Field of the Invention

The present invention relates to a method for recording a data stream having multiple reproduction paths on a high-density recording medium such that the multi-path data stream can be presented seamlessly on path changes during reproduction.

2. Description of the Related Art

The standardization of new high-density read only and rewritable optical disks capable of recording large amounts of high-quality video and audio data has been progressing rapidly and new optical disk related products are expected to be commercially available on the market in the near future. The Blu-ray Disc Rewritable (called ‘BD-RE’ in general) is one example of these new optical disks.

A BD-RE can store a multi-path data stream, e.g., a data stream having multiple stories, multiple parental levels, or multiple angles. Therefore, it is preferable that a disk recording/reproducing apparatus for a BD-RE can make seamless change from a current path to another path during reproduction of a multi-path stream on a BD-RE when a user requests path change.

By the way, the standardization for a high-density read-only optical disk such as a Blu-ray ROM disk (called ‘BD-ROM’) is still under way. A BD-ROM can be also manufactured such that it includes a multi-path data stream.

Therefore, an effective method for enabling a seamless path change during reproduction of a multi-path data stream of such a high-density optical disk is strongly demanded.

### SUMMARY OF THE INVENTION

It is an object of the present invention to provide a recording method for setting a data stream section to prohibit path re-change after path change.

It is another object of the present invention to provide a recording method for compensating bit rates such that every data stream section has total bit rate enough to prevent buffer underrun during a path change.

It is another object of the present invention to provide a recording medium having a multi-path data stream composed of data stream sections that have respective total bit rates enough to prevent buffer underrun during a path change.

A method for recording a data stream having multiple reproduction paths on a recording medium in accordance with the present invention is characterized in that it comprises the steps of: checking whether total bit rate (TBR) of a data stream section pertaining to one path among multiple reproduction paths is lower than a minimum bit rate and, if lower, assigning an additional bit rate to the data stream section such that the TBR of the data stream section is not lower than said minimum bit rate; and recording a multi-path data stream including the data stream section on a recording medium.

A recording medium including a data stream having multiple reproduction paths in accordance with the present invention is characterized in that TBR of an arbitrary data stream section, within the multi-path data stream, of one path among the multiple reproduction paths is not lower than a minimum bit rate that is set to a value enough to prevent buffer underrun during changes in reproduction path.

### BRIEF DESCRIPTION OF THE DRAWINGS

The above features and other advantages of the present invention will be more clearly understood from the following detailed description taken in conjunction with the accompanying drawings, in which:

FIG. 1 illustrates an exemplary embodiment of a recording medium file or data structure according to the present invention;

FIG. 2 illustrates an example of a recording medium having the data structure of FIG. 1 stored thereon;

FIG. 3 is diagram illustrating the structure of an optical disc apparatus where a method for reproducing/recording a multi-path data stream according to the present invention is applied;

FIG. 4 illustrates an example of a no jumping block (NJB) defined by a multi-path data stream recording method in accordance with the invention;

FIG. 5 illustrates a graphical representation of a first method for recording a multi-path data stream while conducting bit rate compensation for entry points in accordance with the invention;

FIG. 6 illustrates a graphical representation of a second method for recording a multi-path data stream while conducting bit rate compensation for entry points in accordance with the invention; and

FIG. 7 illustrates a graphical representation of a third method for recording a multi-path data stream while conducting bit rate compensation for jump units in accordance with the invention.

### DETAILED DESCRIPTION OF THE PREFERRED EMBODIMENTS

In order that the invention may be fully understood, preferred embodiments thereof will now be described with reference to the accompanying drawings.

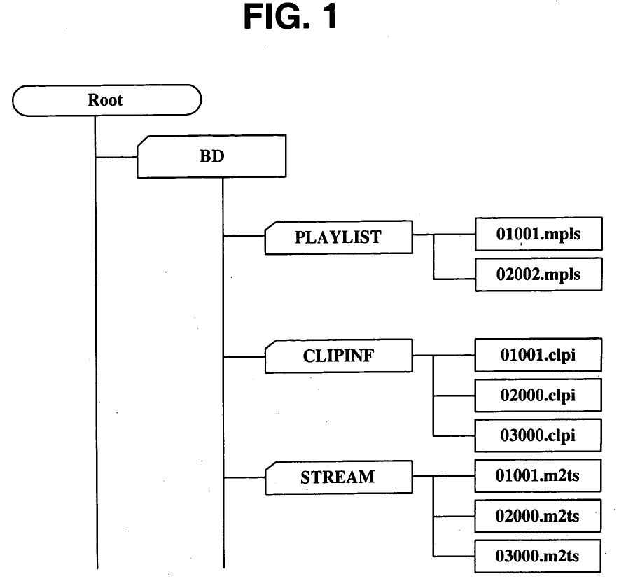

A high-density optical disk, for example, a Blu-Ray ROM (BD-ROM), BD-RE, etc. in accordance with the invention may have a file or data structure for managing reproduction of video and audio data as shown in FIG. 1. Some aspects of the data structure according to the present invention shown in FIG. 1 are the same as the well-known BD-RE standard, as such these aspects will not be described in great detail.

As shown in FIG. 1, the root directory contains at least one BD directory. The BD directory includes general files (not shown), a PLAYLIST directory in which playlist files (e.g., *.mp1s) are stored, a CLIPINF directory in which clip information files (*.clpi) are stored, and a STREAM directory in which MPEG2-formatted A/V stream clip files (*.m2ts), corresponding to the clip information files, are stored.

The STREAM directory includes MPEG2-formatted single-path and/or multi-path A/V stream files that are called clips or clip files. The A/V stream includes source packets of video and audio.

For example, a source packet of video data includes a header and a transport packet. A source packet includes a source packet number, which is generally a sequentially assigned number that serves as an address for accessing the source packet. Transport packets include a packet identifier (PID). The PID identifies the sequence of transport packets to which a transport packet belongs. Each transport packet in the sequence will have the same PID.

The CLIPINF directory includes a clip information file associated with each A/V stream file. The clip information file indicates, among other things, the type of single- or multi-path A/V stream associated therewith, sequence information, program information and timing information.

The PLAYLIST directory includes one or more playlist files. The concept of a playlist has been introduced to promote ease of editing/assembling clips for playback. A playlist file is a collection of playing intervals in the clips. Each playing interval is referred to as a playitem. The playlist file, among other things, identifies each playitem forming the playlist, and each playitem, among other things, is a pair of IN-point and OUT-point that point to positions on a time axis of the clip (e.g., presentation time stamps on an ATC or STC basis).

Expressed another way, the playlist file identifies playitems, each playitem points to a clip or portion thereof and identifies the clip information file associated with the clip. The clip information file is used, among other things, to map the playitems to the clip of source packets.

The general files (not shown) provide general information for managing the reproduction of the A/V streams recorded on the optical disk.

In addition to illustrating the data structure of the recording medium according to an embodiment of the present invention, FIG. 1 represents the areas of the recording medium. For example, the general information files are recorded in one or more general information areas, the playlist directory is recorded in one or more playlist directory areas, each playlist in a playlist directory is recorded in one or more playlist areas of the recording medium, etc.

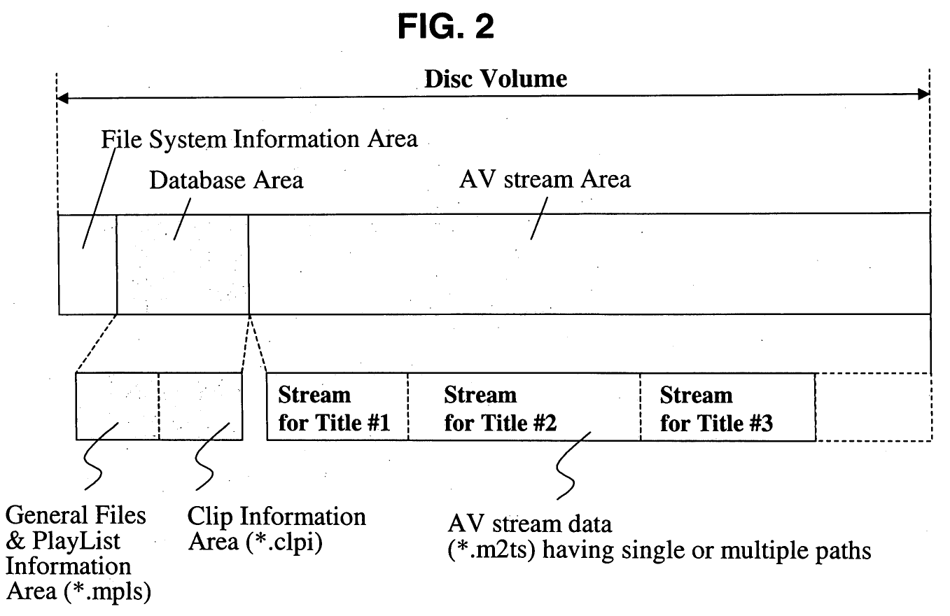

FIG. 2 illustrates an example of a recording medium having the data structure of FIG. 1 stored thereon. As shown, the recording medium includes a file system information area, a data base area and an A/V stream area.

The data base area includes a general information file and playlist information area and a clip information area. The general information file and playlist information area have the general information files recorded in a general information file area thereof, and the PLAYLIST directory and playlist files recorded in a playlist information area thereof. The clip information area has the CLIPINF directory and associated clip information files recorded therein. The A/V stream area has the single- or multi-path A/V streams for the various titles recorded therein.

Video and audio data are typically organized as individual titles; for example, different movies represented by the video and audio data are organized as different titles. Furthermore, a title may be organized into individual chapters in much the same way a book is often organized into chapters.

A single multi-path data stream is associated with a single title, however, it may be recorded as a plurality of clip files, one clip file corresponding to each path.

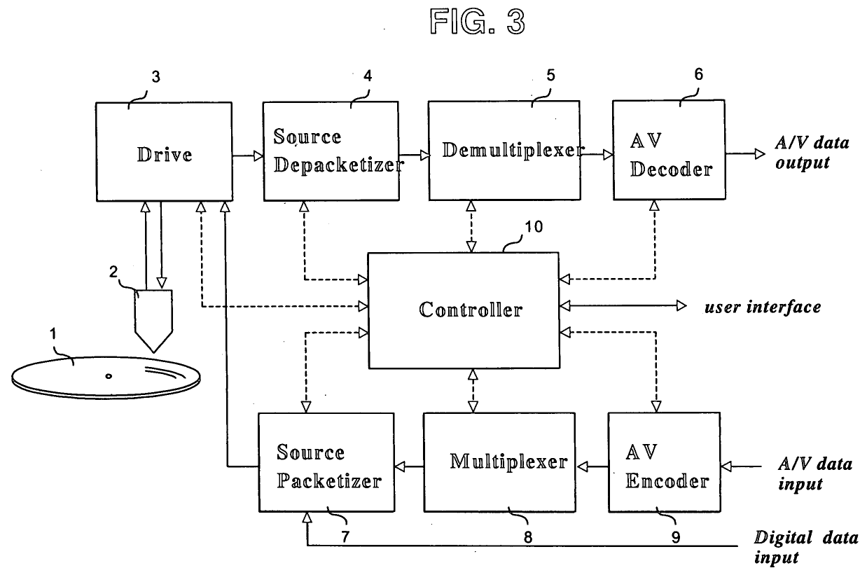

FIG. 3 illustrates a schematic diagram of an embodiment of an optical disk recording and reproducing apparatus according to the present invention. As shown, an AV encoder 9 receives and encodes data (e.g., single- or multi-path movie video and audio data). The AV encoder 9 outputs the encoded data along with coding information and stream attribute information. A multiplexer 8 multiplexes the encoded data based on the coding information and stream attribute information to create, for example, an MPEG-2 transport stream. A source packetizer 7 packetizes the transport packets from the multiplexer 8 into source packets in accordance with the audio/video format of the optical disk.

As shown in FIG. 3, the operations of the AV encoder 9, the multiplexer 8 and the source packetizer 7 are controlled by a controller 10. The controller 10 receives user input on the recording operation, and provides control information to AV encoder 9, multiplexer 8 and the source packetizer 7. For example, the controller 10 instructs the AV encoder 9 on the type of encoding to perform, instructs the multiplexer 8 on the transport stream to create, and instructs the source packetizer 7 on the source packet format. The controller 10 further controls a drive 3 to record on the optical disk the output from the source packetizer 7 as a single clip file or as many clip files as the number of multiple reproduction paths.

The controller 10 also creates the navigation and management information for managing reproduction of the data being recorded on the optical disk. For example, based on information received via the user interface (e.g., instruction set saved on disk, provided over an intranet or internet by a computer system, etc.) the controller 10 controls the drive 3 to record one or more of the data structures of FIGS. 1 and 2 on the optical disk.

During reproduction, the controller 10 controls the drive 3 to reproduce this data structure. Based on the information contained therein, as well as user input received over the user interface (e.g., control buttons on the recording and reproducing apparatus or a remote associated with the apparatus), the controller 10 controls the drive 3 to reproduce the data from the optical disk.

For example, as mentioned above with respect to the embodiments of the present invention, an A/V data stream of one path among multiple reproduction paths included in a single clip file or a plurality of clip files is reproduced based on the navigation information.

The reproduced source packets of an A/V stream of one path are received by a source depacketizer 4 and converted into appropriate data stream (e.g., an MPEG-2 transport packet stream). A demultiplexer 5 demultiplexes the respective data streams into encoded data of video and audio. An AV decoder 6 decodes the encoded data to produce the original data that was fed to the AV encoder 9.

During reproduction, the controller 10 controls the operation of the source depacketizer 4, demultiplexer 5 and AV decoder 6. The controller 10 receives user input on the reproducing operation, and provides control information to AV decoder 6, demultiplexer 5 and the source depacketizer 4. For example, the controller 10 instructs the AV decoder 9 on the type of decoding to perform, instructs the demultiplexer 5 on the transport stream to demultiplex, and instructs the source depacketizer 4 on the source packet format.

While FIG. 3 has been described as a recording and reproducing apparatus, it will be understood that only a recording or only a reproducing apparatus may be provided using those portions of FIG. 3 providing the recording or reproducing function.

Each clip information file associated with each clip file contains entry points (EPs) wherein each EP points some interval of an A/V data stream in the clip file. During reproduction of a multi-path data stream, path changes take place on EP basis.

In addition, the controller 10 performs a jumping operation for path change after a current reproducing point gets out of jump blocking range, namely, no jumping block (NJB) that is set to prevent buffer underrun.

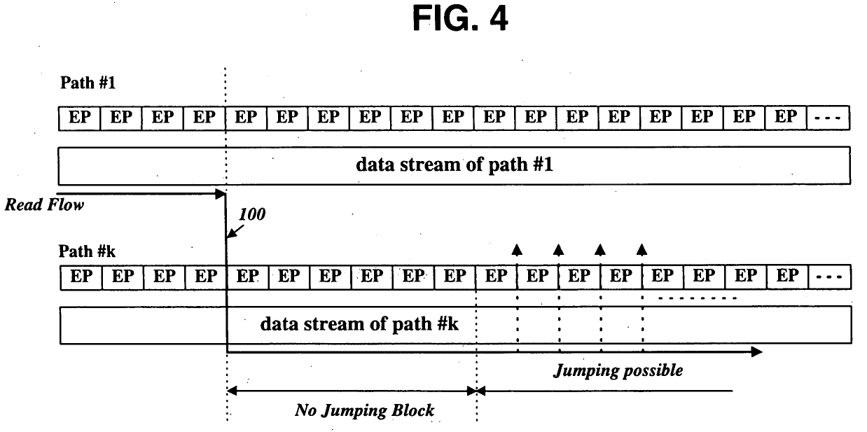

The NJB is defined by a plurality of entry points (EPs) counted from a jumped position. FIG. 4 shows an example where six EPs from a jumped point (100) are set to a NJB. The example of FIG. 4 is adequate to a case that total bit rate (TBR) of data stream intervals pointed by EPs included in the NJB is 24 Mbps or more.

The example of FIG. 4 is also based on an assumption that data enough to prevent buffer underruns can be buffered before a jump to other path after reproduction of a data stream section whose TBR is 24 Mbps or more is completed.

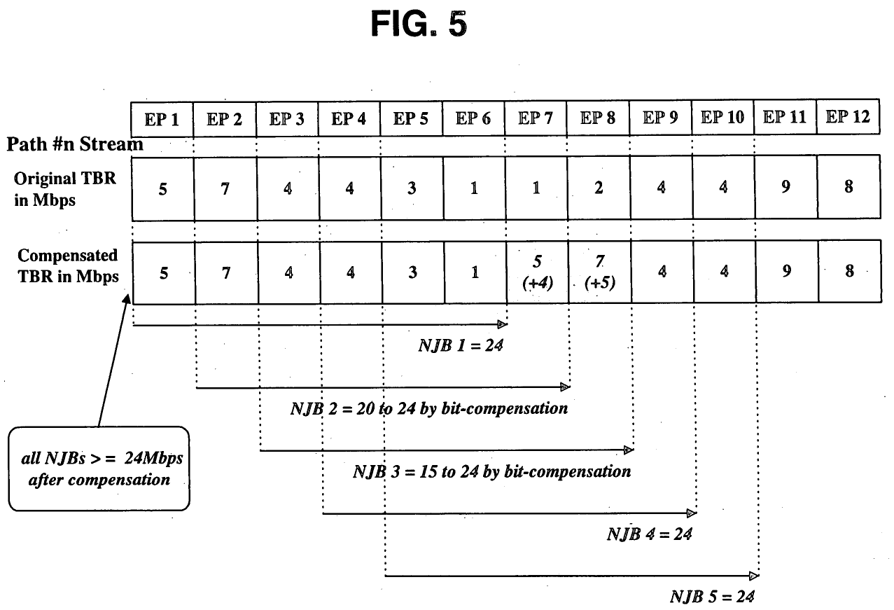

If the TBR of a data stream section corresponding to six EPs constituting an NJB is less than 24 Mbps, bit rate adjustments are conducted for that section. FIG. 5 shows an example of such bit adjustments.

In the example of FIG. 5, the TBR of a data stream section corresponding to the first NJB ‘NJB1’, namely EPs 1 through 6 is 24 Mbps and the TBR of next data stream section, partially overlapped with the previous section, corresponding to the second NJB ‘NJB2’ of EPs 2 through 7 is 20 Mbps because original bit rate of the seventh EP ‘EP7’ is 1 Mbps.

For the second six EPs 2 to 7, the bit rate of the data stream interval corresponding to the seventh EP is adjusted such that the TBR of the data stream section corresponding to the six EPs constituting the second NJB ‘NJB2’ becomes 24 Mbps. In other words, the bit rate of the data corresponding to seventh EP is adjusted and recorded in such a way that bit rate of 4 Mbps is more assigned to the seventh EP in order to make the total bit rate 24 Mbps.

The TBR of a data stream section corresponding to EPs 3 through 8 (in which EP 7 is already bit-compensated) constituting the third NJB ‘NJB3’ is also less than 24 Mbps because the bit rate of original data stream interval corresponding to eighth EP is 2 Mbps. In this case, a bit rate of 5 Mbps is additionally assigned to the eighth EP and then recorded so that the resultant TBR of data stream section pertaining to the third NJB ‘NJB3’ becomes 24 Mbps.

In the above embodiment, additional bit rate is assigned to a data stream interval of only one EP in the event that the TBR of a data stream section has to be compensated to meet the TBR requirement.

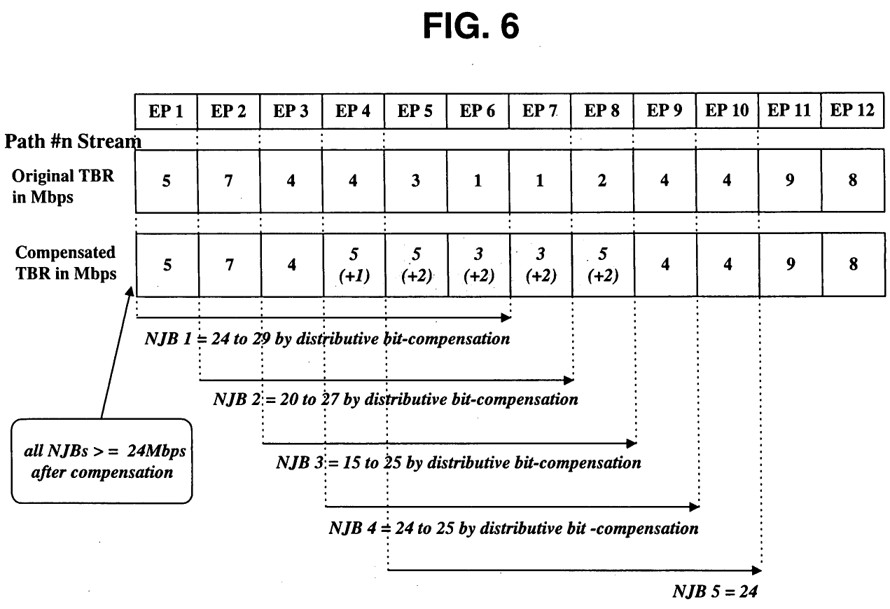

However, additional bit rate can be distributed to several EPs as shown in FIG. 6 in the event that the TBR of a data stream section has to be compensated.

The embodiment illustrated in FIG. 6 is able to improve video quality more than the former embodiment of FIG. 5.

In the embodiment of FIG. 6, the TBRs of original NJBs 1 to 3 before bit rate compensation are 24 Mbps, 20 Mbps, and 15 Mbps, respectively. Therefore, the second NJB ‘NJB2’ needs at least 4 Mbps (4 Mbps additional assignment makes the third NJB 19 Mbps) and the third NJB needs at least 5 Mbps in consideration of 4 Mbps compensation of the second NJB.

That is, more bit rate is assigned to data stream intervals of several EPs in such a manner that at least 4 Mbps is more assigned to a data stream section of six EPs pertaining to the second NJB and at least 9 Mbps to a data stream section of six EPs pertaining to the third NJB at the same time.

For example, the additional bit rate of 9 Mbps is distributed to EPs 4 through 8 by 1 Mbps, 2 Mbps, 2 Mbps, 2 Mbps, and 2 Mbps, as shown in FIG. 6.

In the condition that every NJB has TBR of 24 Mbps or more according to the above embodiments, if path change from Path #1 to Path #k is requested, the controller 10 jumps to a data stream of Path #k (100) during reproduction of a multi-path data stream, and reproduces and buffers Path-k data stream, as illustrated FIG. 4.

If path change from Path #k to #1 is requested again during reproduction of the data stream pertaining to Path #k after the path change from #1 to #k, the controller 10 examines if an EP pointing an interval of Path-k data stream being currently reproduced falls within a preset number of no jump EPs, namely, six that is counted just after path changed position. If the current EP lies within the number of no jump EPs, the controller 10 delays the path changing operation and keeps buffering the Path-k data stream in the buffer.

If another EP of the Path-k data stream interval being reproduced through the jumping delay gets away from the sixth EP, which means enough buffering to prevent buffer underrun, the controller 10 conducts the delayed path changing operation.

While jump and search by the path change to Path #1 is being conducted, the controller 10 makes the Path-k data stream buffered in the buffer be presented through the source depacketizer 4, the demultiplexer 5 and the AV decoder 6. When the path change to Path #1 finishes, the controller 10 begins to reproduce the Path-1 data stream from the jumped location and buffers the reproduced Path-1 data stream next to the remaining Path-k data stream in the buffer, thereby guaranteeing seamless presentation at the path changed stream position from Path #k to #1.

By the way, path change may not be allowed on every EP. Instead, path change may be allowed on every EP group consisting of several EPs, e.g., six EPs that is called a jumping unit (JU). The JUs are not overlapped each other unlike NJBs mentioned in the above embodiments of FIGS. 5 and 6.

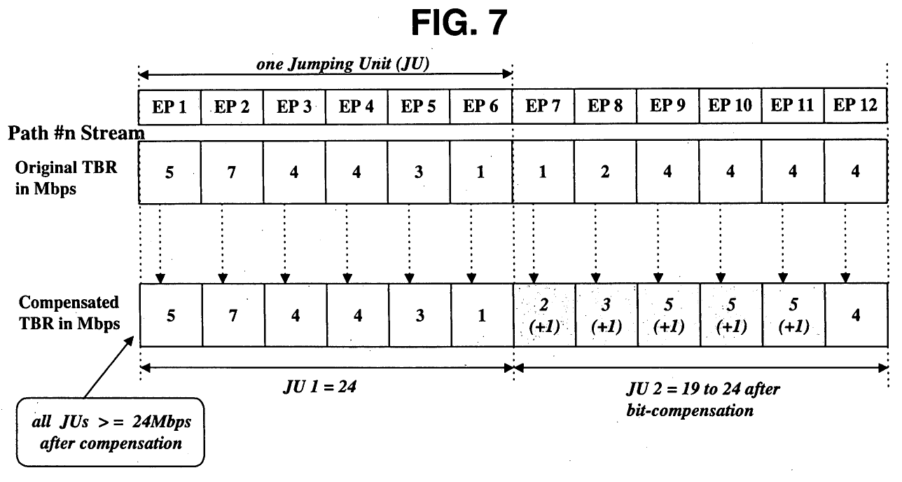

Such an embodiment is illustrated in FIG. 7 where each JU is bit-compensated to be at least 24 Mbps in TBR in order to ensure seamless path change.

In the embodiment of FIG. 7, the TBR of a data stream section corresponding to EPs 1 through 6 constituting the first JU ‘JU1’ is 24 Mbps but the TBR of a data stream section corresponding to EPS 7 through 12 constituting the second ‘JU2’ is 19 Mbps. Therefore, an additional bit rate of 5 Mbps is assigned to one among EPs 7 through 12 in concentrated way or to several EPs of them distributively.

Bit rate is equally distributed in case of distributive bit assignment. For example, an additional bit rate of 5 Mbps may be distributed to EPs 7 through 11 in such a way that a bit rate of 1 Mbps is added to each of them as shown in FIG. 7. By doing this, unnecessary bit rate increase with no improvement in video quality, which is caused by additionally assigning too high a bit rate to one entry point of a low bit rate, can be prevented.

The management information for an NJB or a JU, i.e., the number of EPs and their bit rates, may be recorded in a clip information file or a playlist file.

The above-explained present invention provides a method of recording a multi-path data stream on a high-density optical disk that ensures seamless presentation of video and audio even when the reproduction path is changed during reproduction.

While the invention has been disclosed with respect to a limited number of embodiments, those skilled in the art, having the benefit of this disclosure, will appreciate numerous modifications and variations therefrom. For example, while described with respect to a Blu-ray ROM optical disk in several instances, the present invention is not limited to this standard of optical disk or to optical disks. It is intended that the appended claims cover all such modifications and variations as fall within the true spirit and scope of the invention.

What is claimed is:

1. A method for recording a data stream having multiple reproduction paths on a recording medium, comprising:
checking whether total bit rate (TBR) of a data stream section pertaining to one path among multiple reproduction paths is lower than a minimum bit rate and, if lower, assigning an additional bit rate to the data stream section such that the TBR of the data stream section is not lower than said minimum bit rate; and
recording a multi-path data stream including the data stream section on a recording medium.

2. The method set forth in claim 1, wherein said minimum bit rate is determined to a value enough to prevent buffer underrun during changes in reproduction path.

3. The method set forth in claim 1, wherein said data stream section is a stream range referred by a plurality of entry points, each entry point pointing to an interval of said data stream section.

4. The method set forth in claim 3, wherein the additional bit rate is assigned to a stream interval pertaining to only one entry point.

5. The method set forth in claim 3, wherein the additional bit rate is distributed to a plurality of stream intervals within said data stream section.

6. The method set forth in claim 3, wherein said data stream section whose TBR is to be checked is overlapped with another adjacent data stream section in such a manner that at least one entry point is commonly owned by said two data stream sections.

7. The method set forth in claim 6, wherein a jump for path change during reproduction of the recorded multi-path data stream is allowed on every entry point.

8. The method set forth in claim 3, wherein said data stream section whose TBR is to be checked is not overlapped with another adjacent data stream section.

9. The method set forth in claim 8, wherein a jump for path change during reproduction of the recorded multi-path data stream is allowed on every data stream section not entry point.

10. The method set forth in claim 1, wherein said minimum bit rate is at least 24 Mbps.

11. A recording medium including a data stream having multiple reproduction paths recorded thereon, wherein:
total bit rate (TBR) of an arbitrary data stream section of one path among multiple reproduction paths is not lower than a minimum bit rate that is set to a value enough to prevent buffer underrun during changes in reproduction path.

12. The recording medium set forth in claim 11, wherein said data stream section is a stream range referred by a plurality of entry points, each entry point pointing to an interval of said data stream section.

13. The recording medium set forth in claim 12, wherein said data stream section is overlapped with another adjacent data stream section in such a manner that at least one entry point is commonly owned by said two data stream sections.

14. The recording medium set forth in claim 13, wherein a jump for path change during reproduction of the recorded multi-path data stream is allowed on every entry point.

15. The recording medium set forth in claim 12, wherein said data stream section is not overlapped with another adjacent data stream section.

16. The recording medium set forth in claim 15, wherein a jump for path change during reproduction of the recorded multi-path data stream is allowed on every data stream section not entry point.
